(19) United States
(12) Patent Application Publication
(10) Pub. No.: US 2023/0186385 A1
(43) Pub. Date: Jun. 15, 2023

(54) COMPUTER-IMPLEMENTED SYSTEM AND METHOD OF FACILITATING ARTIFICIAL INTELLIGENCE BASED LENDING STRATEGIES AND BUSINESS REVENUE MANAGEMENT

(71) Applicant: Prometics, Inc., Palo Alto, CA (US)

(72) Inventor: Francois-Regis Masson, Palo Alto, CA (US)

(21) Appl. No.: 18/060,198

(22) Filed: Nov. 30, 2022

Related U.S. Application Data
(60) Provisional application No. 63/288,901, filed on Dec. 13, 2021.
(60) Provisional application No. 63/289,455, filed on Dec. 14, 2021.

(51) Int. Cl. G06Q 40/03

(52) U.S. Cl. CPC G06Q 40/03

(57) ABSTRACT

A system and method of facilitating lending strategies and business revenue management are disclosed. Lagging and forward-looking data from internal and vendor sources are processed and classified based on regulatory compliance and historical data performance testing. Automated lending strategies are developed on the outcome and learning of an artificial intelligence/machine learning engine to optimize the lending business revenue and provide a roadmap to reach the user-defined business revenue target. Automated lending strategies are finalized based on strategy performance and any optional manual changes entered through the user interface. Strategies are combined to assess the global impact on business revenue. Several sets of automated lending strategies which anticipate future trends may be developed based on business, supervisory, or custom economic scenarios. After user review, a lending strategy set may be implemented directly into the business operating systems through APIs or by following a strategy specifications document.

### FIELD

The present disclosure described herein, in general, relates to lending strategies and business revenue management, and more particularly, relates to a computer implemented system and method of lending strategies and business revenue management using artificial intelligence and machine learning techniques.

### BACKGROUND

There are a variety of strategies for banks and other financial institutions for generating loan terms or strategies for individuals and/or businesses. As the number of individuals seeking a loan increases, and the market changes increase (e.g. new inclusive lending market, new decentralize lending, macroeconomic changes, pandemic, global warming), so too does the complexity behind developing a lending strategy.

### SUMMARY

This summary is provided to introduce aspects related to computer implemented systems and methods of facilitating lending strategies and business revenue management and are further described below in detailed description. This summary is not intended to identify essential features of the subject matter nor is it intended for use in determining or limiting the scope of the subject matter.

In some embodiments, a computer implemented system of facilitating lending strategies and business revenue management is disclosed herein. The computer implemented system includes a processor and a memory. The memory is coupled with the processor. The processor executes a plurality of modules stored in the memory. The plurality of modules includes a data import and validation module, a data insights and classification module and an advanced monitoring module, an automated strategy builder module, a combined strategy impact processor, a forecasting and stress testing module, and a business return tracking module. The data import and validation module is configured to process data fields and values from diverse internal and external sources. The data fields and values are validated based on a programmed format. The data insights and classification module and the advanced monitoring module are configured to provide file statistics, data field value distributions, regulatory compliance data field classification, data field performance rating for business process management, and multiple Key Processing Indicators (KPIs) tracking and monitoring suites for lending. The automated strategy builder module is configured to execute in tandem with an artificial intelligence / machine learning module to process and analyze the data input to automatically identify the best lending strategy in terms of business revenue across all specific industry knowledge characteristics of lending dimensions and lending functions. The combined strategy impact processor is configured to process and combine the effects of several new strategies into one business revenue value, calculated based on new dataset field values derived from the application of the new strategies. The forecasting and stress testing module is configured to execute in tandem with an artificial intelligence / machine learning module to process and analyze the new datasets using the new strategies to automatically identify an optimized regression model to forecast business revenue or any other lending Key Process Indicators (KPIs) over a specific time window based on several new strategies, economic and business forecast and stress test scenarios. The business return tracking module is configured to process and deliver a detailed comparison between the user target business revenue and the optimized business revenue. The computer implemented system further includes a technology architecture configured to connect with user internal core data infrastructure, with third-party vendor APIs, public information, and process manual file data import/results export. The computer implemented system further includes a user interface configured to facilitate the functions between modules, provide information and alerts, and allow manual adjustments of strategies with the dynamic update of the business revenue and instant comparison to the user-defined business revenue target. In some embodiment, a computer implemented method of facilitating lending strategies and business revenue management is disclosed herein. A processor imports data fields and values from diverse internal and external sources. The data fields and values are validated based on a programmed format. The processor provides file statistics, data field value distributions, regulatory compliance data field classification, data field performance rating for business process management, and multiple Key Processing Indicators (KPIs) tracking and monitoring suites for lending. The processor processes and analyzes the data input to automatically identify the best lending strategy in terms of business revenue across all specific industry knowledge characteristics of lending dimensions and lending functions. The processor processes and combines the effects of several new strategies into one business revenue value, calculated based on new dataset field values derived from the application of the new strategies. The processor processes and analyzes the new datasets using the new strategies to automatically identify an optimized regression model to forecast business revenue or any other lending Key Process Indicators (KPIs) over a specific time window based on several new strategies, economic and business forecast and stress test scenarios. The processor processes and delivers a detailed comparison between the user target business revenue and the optimized business revenue. The processor connects with user internal core data infrastructure, with third-party vendor APIs, public information. The processor processes manual file data import/results export. The processor displays, on a user device, the functions between modules, information and alerts, and allow manual adjustments of strategies with the dynamic update of the business revenue and instant comparison to the user-defined business revenue target.

In some embodiments, a non-transitory computer readable medium is disclosed herein. The non-transitory computer readable medium stores program of facilitating lending strategies and business revenue management. The program includes programmed instructions for importing data fields and values from diverse internal and external sources. The data fields and values are validated based on a programmed format. The program includes programmed instructions for providing file statistics, data field value distributions, regulatory compliance data field classification, data field performance rating for business process management, and multiple Key Processing Indicators (KPIs) tracking and monitoring suites for lending. The program includes programmed instructions for processing and analyzing the data input to automatically identify the best lending strategy in terms of business revenue across all specific industry knowledge characteristics of lending dimensions and lending functions. The program includes programmed instructions for processing and combining the effects of several new strategies into one business revenue value, calculated based on new dataset field values derived from the application of the new strategies. The program includes programmed instructions for processing and analyzing the new datasets using the new strategies to automatically identify an optimized regression model to forecast business revenue or any other lending Key Process Indicators (KPIs) over a specific time window based on several new strategies, economic and business forecast and stress test scenarios. The program includes programmed instructions for processing and delivering a detailed comparison between the user target business revenue and the optimized business revenue. The program includes programmed instructions for connecting with user internal core data infrastructure, with third-party vendor APIs, public information. The program includes programmed instructions for processing manual file data import/results export. The program includes programmed instructions for displaying on a user device, the functions between modules, information and alerts, and allow manual adjustments of strategies with the dynamic update of the business revenue and instant comparison to the user-defined business revenue target.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer to like features and components.

FIG. 1 is a diagram of a network implementation of a system of facilitating lending strategies and business revenue management, according to example embodiments.

FIG. 2 is a diagram of the system of FIG. 1, according to example embodiments.

FIG. 3 is a diagram of an automated strategy builder module within the system of FIG. 1, according to example embodiments.

FIG. 4 is a diagram of a forecasting lending strategy module of the system of FIG. 1, according to example embodiments.

FIG. 5 is a flow diagram depicting working of a combined strategy impact processor of the system of FIG. 1, according to example embodiments.

FIG. 6 is a flow diagram of a data classification module of the system of FIG. 1, according to example embodiments.

FIG. 7 is a diagram of the technology architecture with the type of customer data input, artificial intelligence / machine learning, and the output features of the system of FIG. 1, in accordance with an embodiment of the present disclosure.

### DETAILED DESCRIPTION

Conventional lending optimization systems suffer from a myriad of shortfalls. For example, conventional lending optimization systems typically describe the main input of information to be transactional data. Such constraint limits the field of application for systems to one type of information. As observed recently, the industry appetite for alternative and more inclusive lending pushes lenders to process additional types of information within the fair lending regulatory guidelines, such as, for example, customer characteristics, customer assets, prior relationship with the lender. Such constraint also limits the predictive strength, the field of application, and accuracy of lending optimization models that the system can produce.

Third-party vendor data sources, systems, and methods to test, validate and integrate them in lending strategy optimization are not available in conventional systems. The third-party vendor data is either approved for immediate live testing or a test is set up in an independent technology environment requiring separate technology resources, security, and vendor access. These methods make the vendor data onboarding difficult. They also may produce inconsistencies in data quality and produce undesired volatility in business revenue results.

While conventional systems may be capable of providing optimization models and reporting, these systems, however, are unable to capture industry knowledge and, instead, require a team of lending industry experts and statisticians to review manually or in separate systems the lending product characteristics (e.g. credit card debt to income, mortgage loan to value), and lending function and program characteristics (e.g. marketing prescreen, underwriting eligibility criteria, account line management). Such limitation either reduces the performance of lending strategies if implemented solely based on the system output or requires the work and interaction of several teams to produce a higher quality strategy that may answer the business needs and revenue targets.

Further, the use of pricing optimizers and other performance optimization when applied across several Key Process Indicators (KPIs) defined by system users may create conflicting results at the portfolio level or the financial institution level. For example, a strategy to grow lower credit risk customer segments with lower volume growth opportunity or a strategy to grow higher risk customer segments with higher volume growth opportunity may conflict. The results may diminish the benefit of a centralized system and may reduce the global performance of the lending business. This set up also makes it difficult for decision makers to tie the critical business metrics, such as business revenue, to a specific lending strategy.

Conventional systems are also unable to provide a solution to manage the criticality of regulatory compliance and reporting in lending. This is currently supported either by additional and independent systems or through manual compliance team review, which adds further strategy review, creates unexpected delays in strategy implementation, and impacts the strategy quality with these implementation delays.

Conventional systems use lagging indicators to predict future losses or business growth and create new lending strategy accordingly. The nature of this process may drive lenders to either make bad judgmental strategy changes that may not be optimized at the company level or completely miss opportunities at the beginning of each credit cycle to expand or tighten lending for the right product, at the right time, and with the right strategy.

Further, conventional systems typically offer a report as the final method step. The optimized rules are presented, and the system results are compared to the business goals. There are several steps that need to be addressed prior to implementation: additional compliance validation steps, the creation of recommendation documents with advanced analysis, and the technology implementation queue entry for the business operating system update and testing. These numerous steps may create rule translation issues as they are passed on from one team to another, analysis discrepancies as team may use different technology, systems or databases, delays in the rule implementation that may reduce the rule performance and business revenue due to the stale information.

One or more techniques described herein improve upon conventional systems by introducing a new concept and paradigm of lending strategy development. As described above, a need exists for improved and centralized modeling and lending strategy systems and methods for optimizing each of the financial products and services within a portfolio managed by a financial services institution.

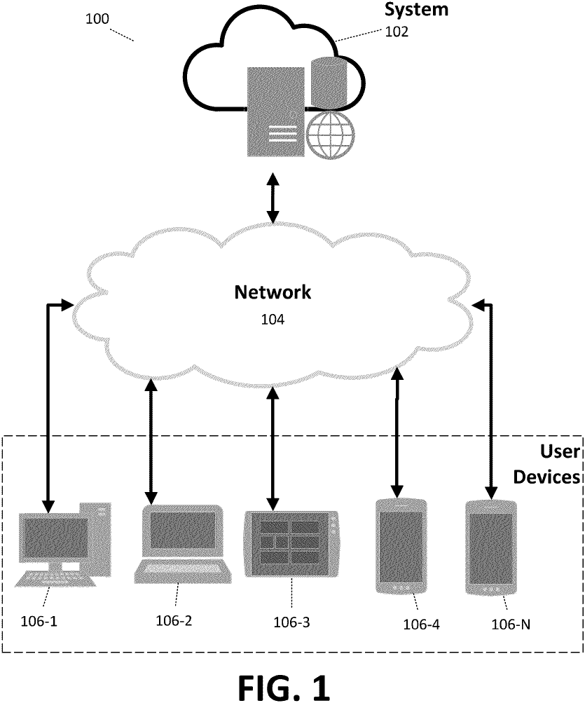

FIG. 1 illustrates a network implementation 100 of a system 102 of facilitating lending strategy and business revenue management is shown, in accordance with an embodiment of the present disclosure. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, a cloud-based computing environment and the like. In some embodiments, the system 102 may be implemented in a cloud-based computing environment. It will be understood that the system 102 also may be accessed by multiple registered users through one or more user devices 106-1, 106-2, 106-3, 106-4, or 106-N. Examples of the user devices 106 may include, and are not limited to, a portable computer, a personal digital assistant, a handheld device, and a workstation. Further, the system 102 may be communicatively coupled with the user devices 106-1, 106-2, 106-3, 106-4, or 106-N, through a network 104.

In some embodiments, the network 104 may be a wireless network, a wired network, or a combination thereof. The network 104 can be implemented as one of the different types of networks, such as intranet, local area network (LAN), wide area network (WAN), the internet, and the like. The network 104 may either be a dedicated network or a shared network. The shared network represents an association of the different types of networks that use a variety of protocols, for example, Hypertext Transfer Protocol (HTTP), Transmission Control Protocol/Intemet Protocol (TCP/IP), Wireless Application Protocol (WAP), a telecommunication network (e.g., 2G/3G/4G/5G) and the like, to communicate with one another. Further the network 105 may include a variety of network devices, including routers, bridges, servers, computing devices, storage devices, and the like.

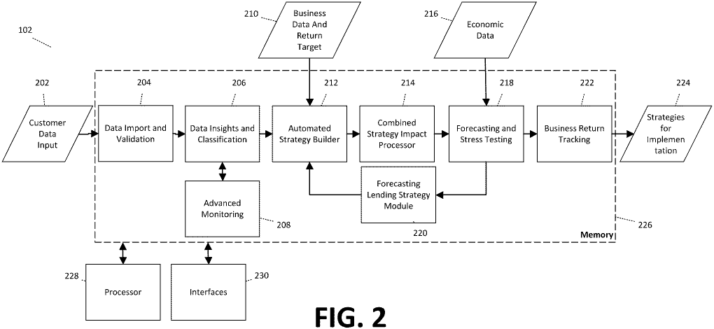

FIG. 2 is a block diagram illustrating the system 102, according to example embodiments. In some embodiments, the system 102 may include a processor 228, an input/output (I/O) interface 230, and a memory 226. The processor 228 may be implemented as one or more microprocessors, microcomputers, microcontrollers, digital signal processors, central processing units, state machines, logic circuitries, and/or any devices that manipulate signals based on operational instructions. Among other capabilities, the processor 228 is configured to fetch and execute computer-readable instructions stored in the memory 226.

The I/O interface 230 may include a variety of software and hardware interfaces, for example, a web interface, a graphical user interface, and the like. The I/O interface 230 may allow the system 102 to interact with the user/consumer directly or through the consumer devices 106. Further, the I/O interface 230 may enable the system 102 to communicate with other computing devices, such as web servers and external data servers (not shown). The I/O interface 230 can facilitate multiple communications within a wide variety of networks and protocol types, including wired networks, for example, LAN, cable, etc., and wireless networks, such as WLAN, cellular, or satellite. The I/O interface 230 may include one or more ports for connecting a number of devices to one another or to another server.

The memory 226 may include any computer-readable medium and computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 226 may include modules and data. It serves, among other things as a repository for storing data processed, received, and generated by one or more of the modules.

The modules may include routines, programs, objects, components, data structures, etc., which perform particular tasks or implement particular abstract data types. In some embodiments, the modules may include the Data Import and Validation module 204, a Data Insights and Classification 206, an Advanced Monitoring module 208, an Automated Strategy Builder module 212, a Combined Strategy Impact Processor 214, a Forecasting and Stress Testing module 218, a Forecasting Lending Strategy Module 220, a Business Return Tracking module 222, and other modules (not shown). The other modules may include programs or coded instructions that supplement applications and functions of the system 102.

The Customer Data Input 202, the Business Data and Return Target 210, and the Economic Data 216, amongst other things, serves as a repository for storing data processed, received, and generated by one or more of the modules. The data may also include a data repository and other data. The system 102 may be accessed by the user device 106 registered with the system 102. The user device 106 may belong to an entity that may offer lending products to its customers (e.g. Financial Institution, Bank, Credit Union, Fintech, DeFi), a credit rating agency, a regulatory institution, an asset management business, a private equity business, a wealth management business, or an equity research business. Further, each of the aforementioned modules is explained in subsequent paragraphs of the specification.

Now referring to FIG. 2, the Customer Data Input 202 may provide customer data to the system 102, such as but not limited to customer characteristics, loan application data, lending performance data, transactional data, and other data. The data may be sourced from the financial institution itself, third-party vendors, or data providers. The Customer Data Input 202 may be imported into the system with the Data Import and Validation module 204. This module may process file of any format known in the art including, for example, XML, CSV, XLSX or import directly via API, previously set up for that specific function. The imported data may go through a validation process, checking diverse data type and value formats that are predefined and programmed in the module, including but not limited to structured and unstructured data import programs. Any data import issues in this process may be surfaced to the user through the interface to be fixed 230. The validated data may be stored in the memory 226.

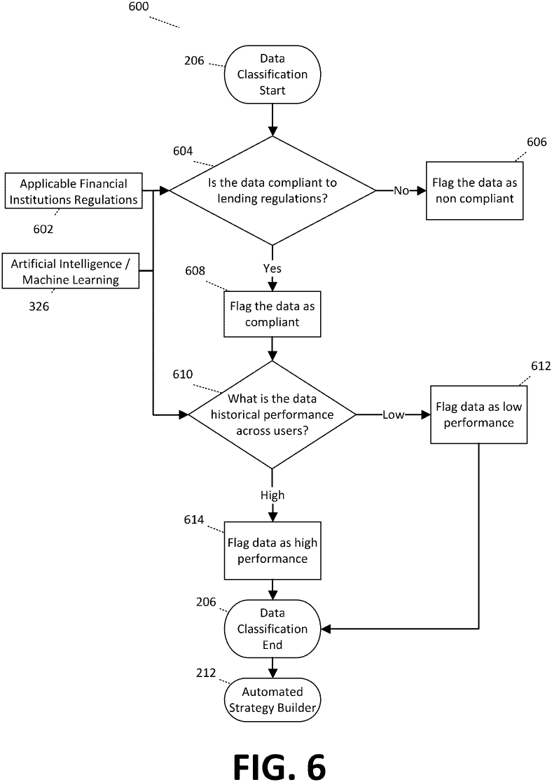

Based upon the successful customer data import and validation, the Data Insights and Classification 206, as shown in FIG. 2, may be configured to provide data insights, as an example data field statistics presented in tables and histograms, and data classification which may be driven by different sets of rules, for example the applicable regulatory compliance and historical data performance testing. A person skilled in the art would easily realize and appreciate that the Data Insights and Classification engine 206 may use advanced deep learning functionalities and technologies for classifying imported data. Specifically, the Data Insights and Classification engine 206 may qualify the imported data fields as regulatory compliant or not, and as high or low data performance based on its historical use in the system across users. Further, as shown in FIG. 6 described below, the artificial intelligence engine may be configured to automatically classify the imported data. It must be understood that the artificial intelligence engine may be adaptively trained via a machine learning module to learn from other system users and from predefined compliance requirements. The classified data may be stored in the data repository 226. The Advanced Monitoring module 208 may provide additional reporting and insights, such as but not limited to predefined portfolio trends of Key Process Indicators (KPI) for lending, customer level and account level lending relationship monthly reporting.

In some embodiments, as shown in FIG. 2, the Automated Strategy Builder 212 may be configured to process the imported and classified data and the Business Data and Return Target 210. For example, the business data may provide insights on the business operation costs and the return target may provide the business Return on Asset (ROA) target. The Automated Strategy Builder 212 module may leverage artificial intelligence to automatically develop lending strategies to optimize the business revenue and may store the strategies in the data repository 226. For example, advanced statical and modeling techniques may be used and is not limited to CHAID tree regression or Entropy measurement for data science. The individual strategies may be catering to specific lending functions and lending dimensions. For example, the strategy may be associated with marketing and credit cards. For each different strategy, different data strategy segments and rules may be provided to the user through the Interfaces 230. The next step, characterized by the Combined Strategy Impact Processor 214, may produce a combined view of the impact of all individual lending strategies together and provide a global business revenue based on this set of strategies. This step may help the user through the Interfaces 230 to be alerted if the new automated strategy set does not meet the provided business revenue target and may allow the user to edit or proceed with the strategy set. Further, the combined strategies performance may be tested over time using the Forecasting and Stress Testing module 218. The Forecasting and Stress Testing 218 module may use advanced analytics and statistical accuracy controls to allow the creation of iterative forecast models and pick the best forecast models across thousands of developed models. This process allows greater accuracy and control than the traditionally used process of building one model for one forecast. For example, advanced statical and modeling techniques in artificial intelligence / machine learning may be used and is not limited to Mean Squared Error (MSE) or Mean Absolute Percentage Error (MAPE) as a machine learning statistical measure to define the accuracy of multiple forecasts. With the help of predefined supervisory agency and user-defined economic data and scenarios in the Economic Data 216, the user may forecast and stress test the new strategy set to validate the revenue performance over time and other dimensions. The Forecasting Lending Strategy Module 220 brings the process beyond any prior art as it may be leveraged to produce a new strategy set for each one of the forecasting and stress testing scenario, leveraging artificial intelligence and machine learning to trend the customer data input into the future, using iteratively the Automated Strategy Builder 212, the Combined Strategy Impact Processor 214, and the Forecasting and Stress Testing modules 218. The Business Return Tracking module 222 may display the individual strategy set business return in comparison to the Business Data and Return Target 210 and automatically provide strategy set detailed documentation and validation. This Business Return Tracking step 222 may help the user check the strategy set details and documentation to move forward with the Strategies for Implementation report creation 224.

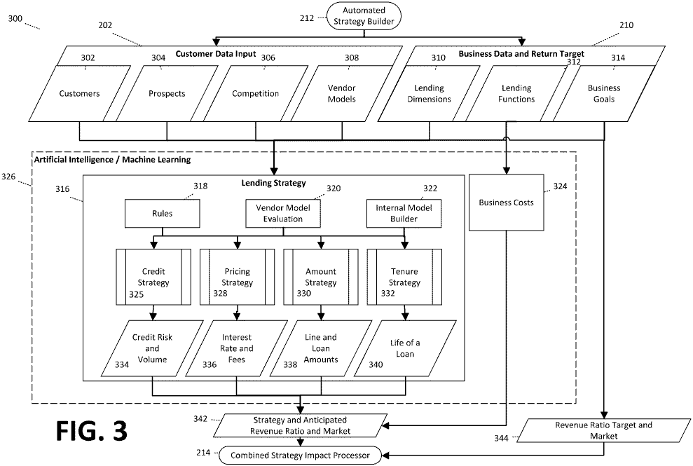

As shown in FIG. 3, a more detailed diagram in accordance with an embodiment of the present disclosure of the Automated Strategy Builder 212 provides examples of interactions between the data inputs, the artificial intelligence / machine learning module 326 and the Automated Strategy and Anticipated Revenue Ratio and Market output 342. The Customer Data Input 202, which may be comprised of Customers 302, Prospects 304, Competition 306, and Vendor Models 308 data, may be loaded into the Artificial Intelligence / Machine Learning module 326 , along with the Business Data and Return Target 210, which may be comprised of Lending Dimensions 310 (e.g. any lending asset type: commercial, retail, business, consumer, wholesale - any lending product: mortgage, auto loan, personal loan, line of credit, credit card - any channel: digital, branch, indirect/direct lending - Business Costs 324 and operations resource details - any lending level: customer level through the financial life cycle or loan level), Lending Functions 312 and lending product life cycle (e.g. Marketing, Product Cross-sell, Underwriting, Pricing, Account Management, Fraud, Collections), and Business Goals 314 (e.g. Business Revenue Target, Market Share). The Artificial Intelligence / Machine Learning module 326 may create lending strategies 316 based on several lending dimensions, which may include lending rules 318, vendor model evaluation 320, and internal model builder 322. These steps may provide the critical building blocks for each lending strategy, such as but not limited to Credit Strategy 325 to define the Credit Risk and Volume 334 components which may define the credit eligibility criteria for a customer to a program or a lending product (i.e. approval/decline rules), Pricing Strategy to define the Interest Rate and Fees 336 components, Amount Strategy 330 to define Line and Loan Amounts 338, Tenure Strategy to define the Life of a Loan 340 and loan term components. The role of the Artificial Intelligence / Machine Learning 326 module may be to optimize the Lending strategy 316 components to maximize business revenues. Provided the Business Costs 324, the optimized Lending Strategy 316 components, the competition 306 market share, the Artificial Intelligence / Machine Learning module 326 may be able to ultimately assess the strategy anticipated Return On Asset (ROA = net income / total assets), Return On Equity (ROE = net income / average shareholders’ equity), or at the minimum a Risk Adjusted Yield (RAY = weighted average coupon rate - net annualized loss rate), and the anticipated market share as part of the Strategy and Anticipated Revenue Ratio and Market 342. Further, the Strategy and Anticipated Revenue Ratio and Market 342 and the business Revenue Ratio Target and Market 344 may help the user assess the potential performance of the strategy set developed in the following Combined Strategy Impact Processor 214. The architecture of this process is new compared to the prior art. For example, the new process may be highlighted by the dynamic introduction of diverse data inputs, including vendor models 308, diverse business data and return target 210, particularly in the lending dimensions 310 and functions 312, a vendor model evaluation 320, and an internal model builder 322 articulated around an automated lending strategy builder 300 powered by Artificial Intelligence / Machine Learning 326. It would require several teams skilled in the art to deliver less coordinated, less accurate and less efficient results.

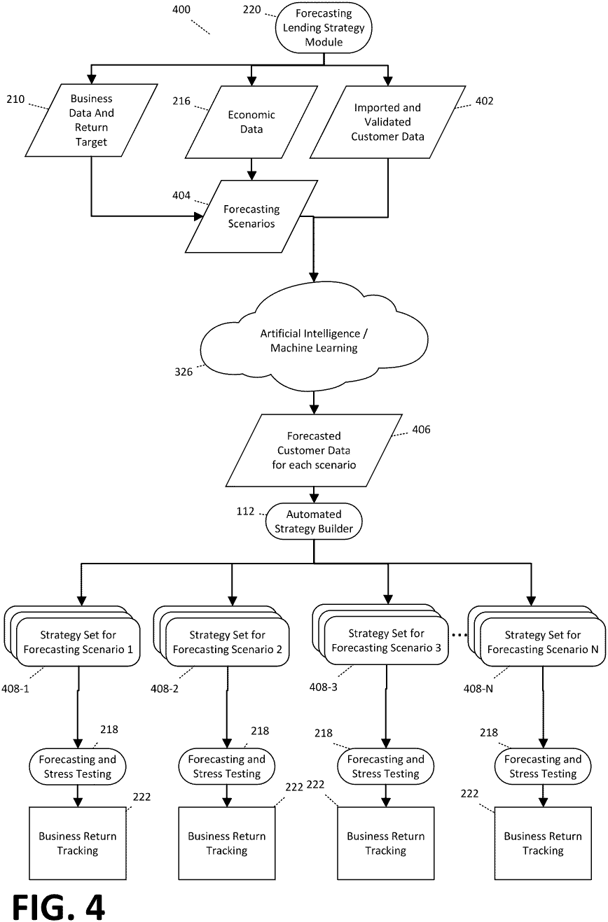

As shown in FIG. 4, a more detailed diagram in accordance with an embodiment of the present disclosure of the Forecasting Lending Strategy module 220 provides examples of interactions between the Business Data and Return Target 210, the Economic Data 216, the Imported and Validated Customer Data 402, the artificial intelligence / machine learning module 326 and the Automated Strategy Builder 112. The artificial intelligence / machine learning module 326 is configured to create new datasets based on economic data 216 and business data and return target 210 forecast scenarios 404 and the customer data input 402, providing forward-looking data; the new datasets for each forecast scenario are used to develop independent sets of strategies; the combined impact of the strategies for each forecast scenario is assessed to calculate a respective business revenue, enabling a forward-looking, scenario-based strategy development and business revenue impact management. One of the purposes of the Forecasting Lending Strategy module 220 may be to enhance the single automated strategy set development process based on lagging information into a forward-looking automated strategy set development process by using the Automated Strategy Builder 112, and the Forecasting and Stress Testing modules 218 in a batch process configuration driven by Forecasting scenarios 404. The Business Data and return Target 210, imported into system 102 by the user and saved into its memory 226 via the interfaces 230, and Economic Data 216, either imported in the same manner by the user or already predefined by the system owner, may provide both custom business forecast scenarios and supervisory economic scenarios as Forecasting Scenarios 404 and may be stored in the memory 226. The Forecasting Scenarios 404 and the Imported and Validated Customer Data 402, produced by the previously described modules on FIG. 2, may be processed by the Artificial Intelligence / Machine Learning module 326 to develop a forward-looking view of each data input based on each of the provided forecasting scenarios 404. Examples of advanced statical and modeling techniques in artificial intelligence / machine learning may be and are not limited to Mean Squared Error (MSE) or Mean Absolute Percentage Error (MAPE) as a machine learning statistical measure to define the accuracy of multiple forecasts and optimize the automated data field forecast. Further, each of the data set representing a specific forecast may be processed in the Automated Strategy Builder 112 and may produce N strategy sets 408-1, 408-2,408-3, 408-N based on N forecasts. As the input data simulated into the future may differ based on different business and/or economic scenarios, the respective forecast strategy sets may also differ. Each one of the Strategy sets may follow the individual strategy process described earlier, creating a specific revenue forecast using the Forecasting and Stress Testing 218 and producing a report comparing the business revenue target and the strategy set revenue forecast. The introduction of new machine learning techniques and the innovative technology process architecture highlighted above may enable the user to produce forward-looking automated strategy sets and corresponding revenue forecasts in a batch process, which is new compared to the prior art defined by one strategy/one revenue forecast process using lagging data as an input for strategy building.

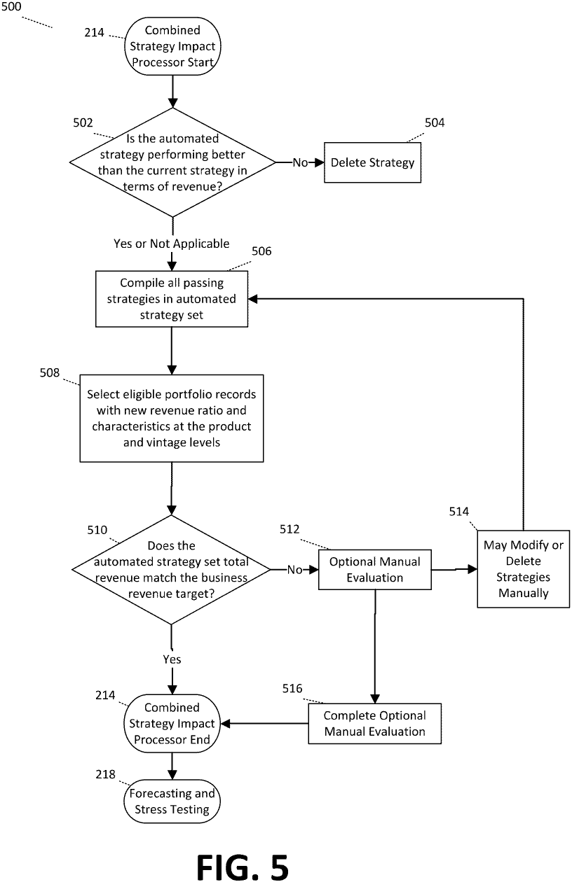

As shown in FIG. 5, the flow diagram depicting working of the combined strategy impact processor 214 within the system 102, in accordance with an embodiment of the present disclosure. At step 502, the processor 228 may access stored data in the memory 226 to test if the individual automated strategy produced by the Artificial Intelligence / Machine Learning module 326 is performing better in terms of revenues 222 (e.g., ROA, ROE, RAY, market share) than the current strategy revenue calculated from the provided business data and return target 210 and Customer Data Input 202. If no, step 504 may proceed with deleting the automated strategy produced by Artificial Intelligence / Machine learning module 326. If yes or there’s not sufficient data to provide a comparison, step 506 may compile all passing or kept strategies in the automated strategy set. At step 508, the processor 228 may create new datasets from the Customer Data Input 202. These new datasets may be the result of the application of the rules 318 defined in the credit strategy 325, pricing strategy 328 (e.g., Risk-based pricing), amount strategy 330, and tenure strategy 332 for all automated lending strategies 316 of the automated strategy set 506 onto the Customer Data Input 202. This process may apply the rules 318 at the product and vintage level to account for any product or function specific strategies (e.g., marketing/acquisition, underwriting rules for the vintages less than 12 months, account management rules for the vintages older than 12 months). Any conflicting rule during this process may result in selecting the least favorable value or decision for the new data (e.g., loan decline decision, highest interest rate). The global impact of the automated strategy set 506 may be evaluated at this step. This comprehensive view introducing a new highly complex process to calculate the global impact of all lending strategies 316 in an automated strategy set 506 does not exist in the prior art and is enabled by the system 102 technology set up using a processor 228, a memory 226, interfaces 230, and an Artificial Intelligence / Machine Learning module 326 to apply new processing steps as previously described. At step 510, the processor 228 may access stored data in the memory 226 to test if the newly calculated automated strategy set total revenue matches the business revenue target (e.g., is equal or above the target). If yes, the Combined Strategy Impact Processor step 214 may end, and the Forecasting and Stress Testing module may start 218. If no, the automated strategy set total revenue results 508 may be displayed to the user on the interfaces 230, along with the detailed strategies 316 that are part of the automated strategy set 506. The user may have the option to manually evaluate 512 and review the strategies. Through the interfaces 230, the user may proceed with the unchanged strategies 516 having a lower total revenue than the expected user revenue target and may get to the end of the Combined Strategy Impact Processor step 214. After step 512 and at step 514, the user may decide to manually modify the rules 318 or delete any of the credit strategy 325 in the strategy set 506. After step 514, the steps 506 and 508 may rerun and the user may visualize dynamically the results of the strategy modifications or deletion in the automated strategy set total revenue 508 values.

As shown in FIG. 6, the flow diagram depicting working of the data insights and classification engine 206 within the system 102, in accordance with an embodiment of the present disclosure. At step 604, the processor 228 may access regulatory requirements 602 in the memory 226 to test if the Customer Data Input 202 is regulatory compliant. Any non-regulatory compliant information may be flagged in the system 102 and have a specific set of rules to stop the use of the information for specific lending tasks. Regulatory compliance involves following external legal mandates set forth by state, federal, or international government 602 (e.g., in the USA: Fair Credit Reporting Act, Equal Credit Opportunity Act, Truth in Lending Act, Real Estate Settlement Procedures Act, Home Mortgage Disclosure Act). For example, tests may be done on Reg. B compliance for consumer lending: prevent applicants from being discriminated against in any aspect of a credit transaction, based on age, gender, ethnicity, nationality, or marital status. Any Customer Data Input 202 related to age, gender, ethnicity, nationality, or marital status may be flagged as “non-compliant Reg. B data” in the system 102 and in the memory 226 using the artificial intelligence / machine learning module 326. For example, this “non-compliant Reg. B data” type of information may not be used for any consumer lending underwriting strategy developed by the automated strategy builder module 212. At a high level, the Customer Data Input 202 may be flagged as regulatory non-compliant 606 or as regulatory compliant 608. At step 610, the regulatory compliant data 608 may be tested based on historical performance across users. This step may leverage the artificial intelligence / machine learning module 326 and stored performance rating in memory 226 for each data field based on previous Customer Data Input 202 and the Vendor Model Evaluation module 320. The data performance may be evaluated based on the ability of the specific data to drive higher revenues or drive lower losses for the financial institutions. The data performance may be captured across all users in the same company in an independent data performance learning model or may be captured across all users of the system 102 using a consortium data performance learning model. The individual data performance rating may take different format, such as but not limited to high/low, high/medium/low, range from 1 to 10, range from 1% to 100%. As an example, a credit score may be rated as high in the historical data performance test as it usually is a good predictor of credit defaults and may drive lower losses for financial institutions. At steps 612 and 614, an example is provided to demonstrate how the data may be flagged as low or high-performance data to drive higher revenues or lower losses. The results of these compliance and performance classification may be accessible by the user from the interface 230 of the system 102. At the end of the Data Insights and Classification engine 206, the classified data may be processed by the Automated Strategy Builder to create regulatory compliant and performant automated strategies for business revenue management. This level of integration and expertise in regulatory compliance and target performance testing at the data level to optimize lending strategies and business revenue management has not been found in the prior art and is now possible to provide through the introduction of new machine learning techniques, the innovative technology process architecture, and steps highlighted above.

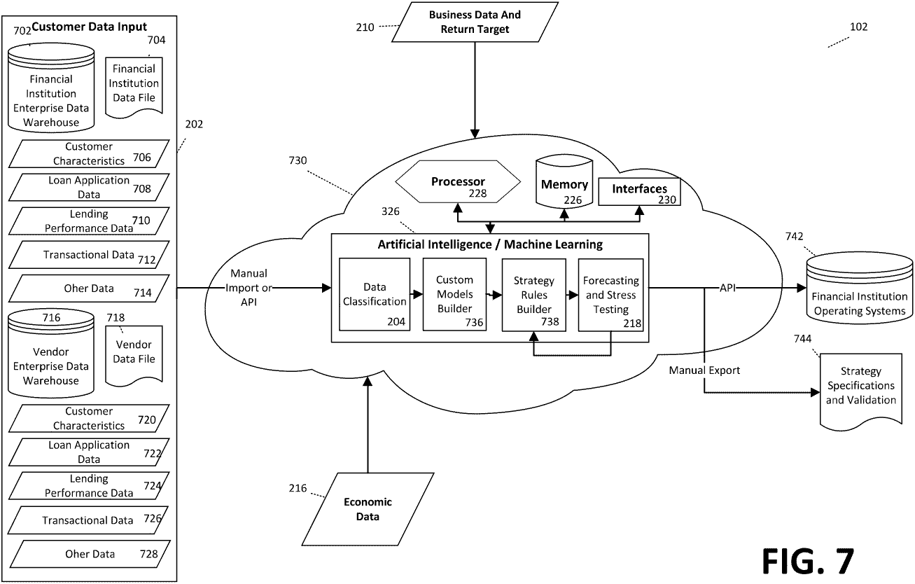

As shown in FIG. 7, a more detailed technology architecture diagram in accordance with an embodiment of the present disclosure of the multiple type of data inputs, a cloud-based platform 730 with a processor 228, a memory 226, the artificial intelligence / machine learning module 326, the steps that are powered by artificial intelligence / machine learning, and the output and connectivity options of the system 102 to the financial institutions or third-party vendor tech stack. The Customer Data Input 202 may be imported into the system 102 from a simple data file manually uploaded by the user from the interfaces 230 (e.g., Financial Institution side 704 / vendor side 718) or through API connections (e.g., Financial Institution side 702 / vendor side 716). The type of data imported may contain customer characteristics 706 / 720 (e.g. name, address, income, financial institution relationship), loan application data 708 / 722 (e.g. product, amount financed, term, pricing, application credit score, length of credit history), lending performance data 710 / 724 (e.g. payment status, balance, monitoring credit score), transactional data 712 / 726 (e.g. retail store detailed transaction spend, cash advanced transactions, debt payment transactions) and any other data 714 / 728 that may be used for lending strategies and business revenue management (e.g. alternative data, utility and phone bills and payments, court decisions, business reviews, social media presence and profiles). The Customer Data Input may be imported and stored in a cloud-based platform 730 memory 226, along with Economic Data 216 and Business Data and Return Target 210. Most of the system functions may be driven by the processor 228, capturing any user input from the interfaces 230, and coordinating the process steps between the memory 226 and the artificial intelligence / machine learning module 326. The artificial intelligence / machine learning module 326 may include but is not limited to powering the following processes: Data Classification 204, Custom Model Builder 736, Strategy Rules Builder 738, Forecasting and Stress Testing 218. The artificial intelligence / machine learning module 326 may be configured to process transactional, non-transactional, customer characteristics, loan application data, loan performance data, third-party vendor data, alternative data, and to supplement the quality of the data with revenue-focused internal models and scores 736 automatically developed based on past customer performance and current customer characteristics. The cloud-based platform 730 may output the results of the lending strategies and business revenue management system 102 in different formats. One example of output may be directly to the Financial Institution Operating Systems (e.g., Loan Origination System or Automated Underwriting Systems) through API 742 and following a strategy validation protocol from the system user on the interfaces 230. This may require an initial technology setup but may enhance the Financial Institution Quality Control strategy implementation results and speed to market to instantly deploy any strategies built and validated in the system 102 by the user. Another example of output may be in the form of a Strategy Specifications and Validation file 744 exported manually from the interfaces 230 of the system 102. The Strategy Specifications and Validation file 744 may be used to inform the Technology teams on how to deploy the new strategies in the operating systems and may serve as documentation for lending governance and internal and external regulatory audits. The following combined elements provide a technology progress from the prior art and a business competitive advantage: cloud-based technology architecture 730 orchestrating multiple artificial intelligence / machine learning processes 326, using of a wide-range of types of data 202, and offering the option to directly connect to the Operating System via API 742, optimizing both the strategy implementation accuracy, quality, and speed to market.

In one embodiment, a computer implemented system of facilitating lending strategies and business revenue management is disclosed. The system may include a processor and a memory coupled with the processor. The processor may execute a plurality of modules stored in the memory. The plurality of modules may include the processing of transactional data, and additional data inputs from the prior art, such as customer characteristics (e.g., income, asset), loan application data, lending performance, and third-party vendor data and models. Further improvements may also include additional industry expertise with key lending components (e.g., credit, financed amount, tenure, lending dimensions, functions, costs, prospect, competition) to get a better picture of the customer response, behavior, and risk. The system may further expand the prior art features and introduce third-party vendor data and a module to control, validate, and share data insights across system users. The business operations may involve the system to be interconnected with hard-wired or wireless communication lines with third-party vendor data, creating a marketplace for best-in-class external lending data and models. As an improvement from the prior art, a module may also define the method of testing for fair lending and regulatory compliance the data and the strategies related to the portfolio of financial products. One example may be a strategy stress testing module, which may also help support economic capital requirements for the lending industry. The system may further include the centralized modeling and business revenue optimization tool, automatically evaluating each of the financial products in the portfolio and defining the strategy business rules for the financial product under evaluation. Furthermore, the system may include an artificial intelligence / machine learning module for advanced optimizations, including but not limited to custom lending model development, lending strategy development, forecasting regression problems and accuracy evaluation. The system may improve the prior art and define, at the financial institution level, how to select the automated strategies to maximize the expected overall performance across all portfolios and in relation to the business lending revenue target. Furthermore, the system may include an interactive dashboard module with business revenue target data entry, a strategy rule definition manual override interface, and options to test instantly alternative business scenarios, regulatory economic scenarios, and user defined custom scenarios in forecasting and stress testing. The system may further include an expansion to the traditional loss and revenue forecasting process and provide an additional forecasting lending strategy module, predicting future portfolio behaviors from past portfolio data and forecasting portfolio changes using the artificial intelligence / machine learning module. This forecasting lending strategy module may offer to the lender the possibility to anticipate credit cycle business opportunities and economic downturns not only at the loss, revenue, and economic capital level per regulatory requirements, but at the lending strategy level and get a head start on the competition at maximizing revenues. A set of strategies for each economic forecast scenario may be developed for all lending products and across the full life cycle lending functions: marketing, underwriting, account management, and collections. The system may further expand the prior art technology integration and may include a direct connection to the financial institution operating systems. The optimized lending strategies of the financial product under evaluation may be transmitted to the financial institution either in the form of a document, or directly to the operating systems via Application Programming Interface (API).

In another embodiment, a computer implemented method of facilitating lending strategies and business revenue management is disclosed. The method may include using a processor and a memory coupled with the processor. The method may further include the processing of transactional data, and additional data inputs from the prior art, such as customer characteristics (e.g., income, asset), loan application data, lending performance, and third-party vendor data and models. Further improvements may also include additional industry expertise with key lending components (e.g., credit, financed amount, tenure, lending dimensions, functions, costs, prospect, competition) to get a better picture of the customer response, behavior, and risk. The method may further expand the prior art features and introduce third-party vendor data and rules to control, validate, and share data insights across users. The business operations may involve a method, via the processor, that interconnects with hard-wired or wireless communication lines with third-party vendor data, creating a marketplace for best-in-class external lending data and models. As an improvement from the prior art, a set of rules may also define the method of testing for fair lending and regulatory compliance the data and the strategies related to the portfolio of financial products. One example may be on strategy stress testing, which may also help support economic capital requirements for the lending industry. The method may further include the centralized modeling and business revenue optimization tool, via the processor, automatically evaluating each of the financial products in the portfolio and defining the strategy business rules for the financial product under evaluation. Furthermore, the method may include advanced optimizations, including but not limited to custom lending model development, lending strategy development, forecasting regression problems and accuracy evaluation. The method may improve the prior art and define, at the financial institution level, how to select the automated strategies, via the processor, to maximize the expected overall performance across all portfolios and in relation to the business lending revenue target. Furthermore, the method may include displaying, via the processor, on a user device, the business revenue target data entry, a strategy rule definition manual override interface, and options to test instantly alternative business scenarios, regulatory economic scenarios, and user defined custom scenarios in forecasting and stress testing. The method may further include, via the processor, an expansion to the traditional loss and revenue forecasting process and provide an additional forecasting lending strategy module, predicting future portfolio behaviors from past portfolio data and forecasting portfolio changes using artificial intelligence / machine learning. This forecasting lending strategy module may offer to the lender the possibility to anticipate credit cycle business opportunities and economic downturns not only at the loss, revenue, and economic capital level per regulatory requirements, but at the lending strategy level and get a head start on the competition at maximizing revenues. A set of strategies for each economic forecast scenario may be developed for all lending products and across the full life cycle lending functions: marketing, underwriting, account management, and collections. The method may further expand the prior art technology integration and may include a direct connection, via the processor, to the financial institution operating systems. The optimized lending strategies of the financial product under evaluation may be transmitted to the financial institution either in the form of a document, or directly to the operating systems via API.

In yet another embodiment, non-transitory computer readable medium storing a program of facilitating lending strategies and business revenue management is disclosed. The program may further include programmed instructions for the processing of transactional data, and additional data inputs from the prior art, such as customer characteristics (e.g., income, asset), loan application data, lending performance, and third-party vendor data and models. Further improvements may also include additional industry expertise with key lending components (e.g., credit, financed amount, tenure, lending dimensions, functions, costs, prospect, competition) to get a better picture of the customer response, behavior, and risk. The program may further include further programmed instructions to expand the prior art features and introduce third-party vendor data and rules to control, validate, and share data insights across users. The business operations may involve a program with programmed instructions to interconnect with hard-wired or wireless communication lines with third-party vendor data, creating a marketplace for best-in-class external lending data and models. As an improvement from the prior art, programmed instructions may also define the program of testing for fair lending and regulatory compliance the data and the strategies related to the portfolio of financial products. One example may be on strategy stress testing, which may also help support economic capital requirements for the lending industry. The program may further include programmed instructions on the centralized modeling and business revenue optimization tool, automatically evaluating each of the financial products in the portfolio and defining the strategy business rules for the financial product under evaluation. Furthermore, the program may include written instructions on advanced optimizations, including but not limited to custom lending model development, lending strategy development, forecasting regression problems and accuracy evaluation. The program may include programmed instructions to improve the prior art and define, at the financial institution level, how to select the automated strategies to maximize the expected overall performance across all portfolios and in relation to the business lending revenue target. Furthermore, the program may include programmed instructions for displaying, on a user device, the business revenue target data entry, a strategy rule definition manual override interface, and options to test instantly alternative business scenarios, regulatory economic scenarios, and user defined custom scenarios in forecasting and stress testing. The program may further include programmed instructions to expand the traditional loss and revenue forecasting process and provide an additional forecasting lending strategy module, predicting future portfolio behaviors from past portfolio data and forecasting portfolio changes using artificial intelligence / machine learning. This forecasting lending strategy module may offer to the lender the possibility to anticipate credit cycle business opportunities and economic downturns not only at the loss, revenue, and economic capital level per regulatory requirements, but at the lending strategy level and get a head start on the competition at maximizing revenues. A set of strategies for each economic forecast scenario may be developed for all lending products and across the full life cycle lending functions: marketing, underwriting, account management, and collections. The program may further include programmed instructions to expand the prior art technology integration and may include programmed instructions to set up a direct connection to the financial institution operating systems. The optimized lending strategies of the financial product under evaluation may be transmitted to the financial institution either in the form of a document, or directly to the operating systems via API.

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items.

It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated but is to be accorded the widest scope consistent with the principles and features described herein.

While aspects of the described system and method of facilitating lending strategy and business revenue management may be implemented in any number of different computing systems, environments, and/or configurations, the embodiments may be described in the context of the following exemplary system.

What is claimed is:

1. A computer implemented system of facilitating lending strategies and business revenue management, the system comprising:
a processor; and
a memory coupled with the processor, wherein the processor executes a plurality of modules stored in the memory, the plurality of modules comprising:
a Data Import and Validation module configured to process data fields and values from diverse internal and external sources, wherein the data fields and values are validated based on a programmed format;
a Data Insights and Classification module and an Advanced Monitoring module configured to provide file statistics, data field value distributions, regulatory compliance data field classification, data field performance rating for business process management, and multiple Key Processing Indicators (KPIs) tracking and monitoring suites for lending;
an Automated Strategy Builder module configured to execute in tandem with an artificial intelligence / machine learning module to process and analyze data input to automatically identify a best lending strategy in terms of business revenue across all specific industry knowledge characteristics of lending dimensions and lending functions;
a Combined Strategy Impact Processor configured to process and combine effects of several new strategies into one business revenue value, calculated based on new dataset field values derived from application of the new strategies;
a Forecasting and Stress Testing module configured to execute in tandem with the artificial intelligence / machine learning module to process and analyze the new datasets using the new strategies to automatically identify an optimized regression model to forecast business revenue or any other lending Key Process Indicators (KPIs) over a specific time window based on several new strategies, economic and business forecast, and stress test scenarios;
a Business Return Tracking module configured to process and deliver a detailed comparison between a user target business revenue and the optimized business revenue;
a technology architecture configured to connect with user internal core data infrastructure, with third-party vendor APIs, public information, and process manual file data import/results export;
a user interface configured to facilitate functions between modules, provide information and alerts, and allow manual adjustments of strategies with dynamic update of the business revenue and instant comparison to the user target business revenue.

2. The system of claim 1, wherein the artificial intelligence / machine learning module is configured to process data comprising transactional, non-transactional, customer characteristics, loan application data, loan performance data, third-party vendor data, alternative data, and to supplement the data with revenue-focused internal models and scores automatically developed based on past customer performance and current customer characteristics.

3. The system of claim 2, wherein the artificial intelligence / machine learning module is configured to classify the imported data into several segments using regulatory compliance and historical data performance across users and businesses.

4. The system of claim 3, wherein the artificial intelligence / machine learning module is configured and supplemented with lending industry dimensions and functions to drive processes, interfaces, KPIs, strategies, forecasts to primarily optimize lending business revenues.

5. The system of claim 4, wherein the artificial intelligence / machine learning module is configured to create new datasets based on economic and business forecast scenarios and the data input, providing forward-looking data; the new datasets for each forecast scenario are used to develop independent sets of strategies; the combined impact of the strategies for each forecast scenario is assessed to calculate a respective business revenue, enabling a forward-looking, scenario-based strategy development and business revenue impact management.

6. The system of claim 5, wherein the artificial intelligence / machine learning module is configured to combine the impact of a group of strategies into a global business revenue forecasted over time, using the strategy characteristics, product, and lending function specifics, and resolving any individual strategy impact conflicts.

7. A computer implemented method of facilitating lending strategies and business revenue management, the method comprising:
importing, via a processor, data fields and values from diverse internal and external sources, wherein the data fields and values are validated based on a programmed format;
providing, via the processor, file statistics, data field value distributions, regulatory compliance data field classification, data field performance rating for business process management, and multiple Key Processing Indicators (KPIs) tracking and monitoring suites for lending;
processing and analyzing, via the processor, data input to automatically identify a best lending strategy in terms of business revenue across all specific industry knowledge characteristics of lending dimensions and lending functions;
processing and combining, via the processor, effects of several new strategies into one business revenue value, calculated based on new dataset field values derived from application of the several new strategies;
processing and analyzing, via the processor, the new datasets using the new strategies to automatically identify an optimized regression model to forecast business revenue or any other lending Key Process Indicators (KPIs) over a specific time window based on several new strategies, economic and business forecast, and stress test scenarios;
processing and delivering, via the processor, a detailed comparison between user target business revenue and the optimized business revenue;
connecting, via the processor, with user internal core data infrastructure, with third-party vendor APIs, public information, and
processing, via the processor, manual file data import/results export;
displaying, via the processor, on a user device, functions between modules, information, and alerts, and allow manual adjustments of strategies with dynamic update of the business revenue and instant comparison to the user target business revenue.

8. The method of claim 7, further comprising processing, via the processor, data comprising transactional, non-transactional, customer characteristics, loan application data, loan performance data, third-party vendor data, alternative data, and supplementing the data with revenue-focused internal models and scores automatically developed based on past customer performance and current customer characteristics.

9. The method of claim 8, further comprising classifying, via the processor, the imported data into several segments using regulatory compliance and historical data performance across users and businesses.

10. The method of claim 9, further comprising supplementing, via the processor, with lending industry dimensions and functions and driving processes, interfaces, KPIs, strategies, forecasts to primarily optimize lending business revenues.

11. The method of claim 10, further comprising creating, via the processor, new datasets based on economic and business forecast scenarios and the data input, providing forward-looking data; the new datasets for each forecast scenario are used to develop independent sets of strategies; a combined impact of the strategies for each forecast scenario is assessed to calculate a respective business revenue, enabling a forward-looking, scenario-based strategy development and business revenue impact management.

12. The method of claim 11, further comprising combining, via the processor, the impact of a group of strategies into a global business revenue forecasted over time, using the strategy characteristics, product and lending function specifics, and resolving any individual strategy impact conflicts.

13. A non-transitory computer readable medium storing program of facilitating lending strategies and business revenue management, the program comprising programmed instructions for:
importing data fields and values from diverse internal and external sources, wherein the data fields and values are validated based on a programmed format;
providing file statistics, data field value distributions, regulatory compliance data field classification, data field performance rating for business process management, and multiple Key Processing Indicators (KPIs) tracking and monitoring suites for lending;
processing and analyzing data input to automatically identify a best lending strategy in terms of business revenue across all specific industry knowledge characteristics of lending dimensions and lending functions;
processing and combining effects of several new strategies into one business revenue value, calculated based on new dataset field values derived from application of the several new strategies;
processing and analyzing the new datasets using the new strategies to automatically identify an optimized regression model to forecast business revenue or any other lending Key Process Indicators (KPIs) over a specific time window based on several new strategies, economic and business forecast and stress test scenarios;
processing and delivering a detailed comparison between user target business revenue and the optimized business revenue;
connecting with user internal core data infrastructure, with third-party vendor APIs, public information, and
processing manual file data import/results export;
displaying on a user device, functions between modules, information and alerts, and allow manual adjustments of strategies with dynamic update of the business revenue and instant comparison to the user target business revenue.

14. The non-transitory computer readable medium of claim 13, wherein the program further comprises programmed instructions for processing data comprising transactional, non-transactional, customer characteristics, loan application data, loan performance data, third-party vendor data, alternative data, and supplementing the data with revenue-focused internal models and scores automatically developed based on past customer performance and current customer characteristics.

15. The non-transitory computer readable medium of claim 14, wherein the program further comprises programmed instructions for classifying the imported data into several segments using regulatory compliance and historical data performance across users and businesses.

16. The non-transitory computer readable medium of claim 15, wherein the program further comprises programmed instructions for supplementing with lending industry dimensions and functions and driving processes, interfaces, KPIs, strategies, forecasts to primarily optimize lending business revenues.

17. The non-transitory computer readable medium of claim 16, wherein the program further comprises programmed instructions for creating new datasets based on economic and business forecast scenarios and the data input, providing forward-looking data; the new datasets for each forecast scenario are used to develop independent sets of strategies; a combined impact of the strategies for each forecast scenario is assessed to calculate a respective business revenue, enabling a forward-looking, scenario-based strategy development and business revenue impact management.

18. The non-transitory computer readable medium of claim 17, wherein the program further comprises programmed instructions for combining the impact of a group of strategies into a global business revenue forecasted over time, using the strategy characteristics, product and lending function specifics, and resolving any individual strategy impact conflicts.
